(19) United States
(12) Patent Application Publication
(10) Pub. No.: US 2007/0223994 A1
(43) Pub. Date: Sep. 27, 2007

(54) INTEGRATED LOCKING DEVICE

(76) Inventor: Murray Cohen, Middle Island, NY (US)

Correspondence Address: NIXON PEABODY, LLP, 401 9TH STREET, NW, SUITE 900, WASHINGTON, DC, 20004-2128, US

(21) Appl. No.: 11/675,760

(22) Filed: Feb. 16, 2007

Related U.S. Application Data
(63) Continuation-in-part of application No. 10/938,499, filed on Sep. 13, 2004, now Pat. No. 7,179,011.

(51) Int. Cl. F16B 7/00

(52) U.S. Cl. 403/376

(57) ABSTRACT

The invention provides an actuator piston and rod-end locking assembly for locking two fittings together. The locking assembly comprises a first fitting, a second fitting, a locking support body slidably mounted on the first fitting and rotationally engaged to both the second fitting and the first fitting, a locking ring element threadably connected to the first fitting and positioned within a recessed portion of the locking support body, and an expansion spring element positioned within the recessed portion of the locking support body in substantial rotational engagement with the locking ring element, thereby preventing inadvertent rotation of the locking ring element within the recessed portion relative to the first fitting. Internal locking threads of the locking ring element rotationally engage with an external threaded portion of the first fitting to form a rotationally locked configuration of the locking ring element and the first fitting, thereby preventing rotation of the locking ring element relative to the first fitting, and further preventing axial separation of the first fitting from the second fitting.

### RELATED APPLICATION DATA

This application is a continuation-in-part of U.S. patent application Ser. No. 10/938,499, filed Sep. 13, 2004, which is hereby incorporated by reference in its entirety.

### BACKGROUND OF THE INVENTION

1. Technical Field

This invention relates generally to a locking device for locking one end of a rod to an end of an element to prevent inadvertent separation, and specifically, to such a device for use in the airline industry.

2. Description of Related Art

Most military and commercial aircraft utilize combinations of bellcranks, push/pull rods, bungees (spring loaded pushrods) and hydraulic actuators to operate flight controls and landing gear systems. Since bungees and hydraulic actuators have a tendency to produce relative rotary motion during operation, system integrity has frequently depended upon anti-rotation locking devices to prevent such motion. Those skilled in the art strive to meet the specifications of military and government regulations for airline safety. The specifications and regulations that govern the design and construction of aircraft systems include MIL-F-9490 General Specification for Flight Control System Design Installation and Test of Piloted Aircraft (U.S. Air Force), General Specification for Design and Construction of Aircraft Weapon Systems SD24L (U.S. Navy), Military Specifications MIL-F-18372 Flight Control Systems: Design, Installation and Test of Aircraft, and the Code of Federal Regulations 14, Aeronautics and Space. The invention is in strict compliance with the above-noted specifications and regulations, whereas existing standard rod end locking devices may not be in strict compliance.

These standards attempted to preclude human error of installation by providing tabs, slots, and grooves to integrate the locking devices. However, the installation of components such as those described above can be forced, with the assembly of the elements being incorrect regardless of the efforts made to ensure correct installations. It has been reported that over one-third of aircraft inspected for standards compliance contained improperly assembled components, and over one-fourth of these were critical linkages. A disconnect of only one component can cause a loss of linkage from pilot to control members. The consequence of such a failure could result in uncontrollable flight or an uncontrollable landing, and possibly the subsequent loss of an airplane.

For example, existing locking devices are highly dependent upon safety wire that is designed to prevent a jam nut from backing off. If the jam nut backs off the locking device may eventually disconnect due to vibration. It is possible for a technician to improperly install standard rod-end locking devices backwards, neglect to tighten any jam nuts with sufficient torque, or inadvertently omit safety wiring. Additionally, the components may be incorrectly assembled with tabs and slots being misaligned. Moreover, any exposure of the locking device to lubricants, such as oil or grease, can reduce the friction between the piston rod and any jam nuts, thereby accelerating the loosening of those components. Any of these mistakes could result in a catastrophic failure because failure of a locking device can lead to a total failure of a particular control system. Loss of a control system can render a pilot helpless and leave the aircraft uncontrollable.

U.S. Pat. No. 5,362,110 issued on Nov. 8, 1994, to Bynum discloses a capture device that prevents vibrational disassembly of fluid tubing couplers and fasteners for hydraulic, pneumatic, and fuel systems on aircraft. Two components of a coupling are held together when a capture device on one component engages a shoulder on the second component. The capture device and the shoulder act to prevent axial separation of the two components. However, rather than latch and spring components, the capture device consists of tangs which depend on the stiffness of the tang material to lock onto the other component. In addition, the purpose of the tangs is not preventing axial separation but preventing relative rotation by creating a ratcheting effect with the second component. Furthermore, no mechanisms operate independently of the tangs in case the tangs fail or are not properly engaged. Also, only the torque from a wrench is necessary to disengage the capture device. For example, spring locks do not need to be compressed to unlock the components.

U.S. Pat. No. 4,684,284 issued on Aug. 4, 1987, to Bradley, Jr., discloses an anti-rotation lock assembly that uses wedge keys in combination with a jam nut. However, the patent does not disclose the use of a nut with a special locking thread form or other mechanism to resist backing off.

U.S. Pat. No. 4,232,978 issued on Nov. 11, 1980, to Cohen discloses a double locking device for securing actuator rods to rod-ends which precludes the possibility of disengagement by providing a double locking feature with safety wiring. However, the use of the double locking device requires significant modification to the existing components to be locked, and thus, is undesirable for many applications.

Similarly, U.S. Pat. No. 4,274,754 issued on Jun. 23, 1981, to Cohen discloses a double locking device with a jam nut feature that precludes the possibility of reverse assembly. However, since the device of the '754 patent uses the same core locking device as the '978 patent, the use of the double locking device also requires significant modification to the existing components to be locked, and thus, is undesirable for many applications.

### SUMMARY OF THE INVENTION

The invention relates generally to an actuator piston and rod-end locking assembly for locking two fittings together. The locking assembly comprises a first fitting including an exterior threaded portion, a second fitting including an interior threaded portion, the second fitting being threadably connected to the first fitting via the interior threaded portion, a locking support body slidably mounted on the first fitting and rotationally engaged to both the second fitting and the first fitting, the locking support body including a recessed portion that extends longitudinally along the first fitting away from the second fitting, a locking ring element including internal locking threads, the locking ring element being threadably connected to the first fitting and positioned within the recessed portion of the locking support body such that the locking support body is axially compressed between the locking ring element and the second fitting, and an expansion spring element positioned within the recessed portion of the locking support body in substantial rotational engagement with the locking ring element, the expansion spring element being adapted to prevent inadvertent rotation of the locking ring element within the recessed portion relative to the first fitting. The internal locking threads of the locking ring element rotationally engage with the external threaded portion of the first fitting to form a rotationally locked configuration of the locking ring element and the first fitting, thereby preventing rotation of the locking ring element relative to the first fitting, and further preventing axial separation of the first fitting from the second fitting.

In addition, the substantial rotational engagement between the locking ring element and the expansion spring can preferably be overcome upon an application of sufficient torque upon the locking ring element. Furthermore, the expansion spring can be retained within the recessed portion of the locking support body by one or more retaining elements, for example, one or more grooves in the recessed portion. Similarly, the locking ring element can be retained within the recessed portion of the locking support body by one or more retaining elements, for example, a retaining pin or one or more longitudinal limit stops. Also, the locking ring element and the expansion spring can be predisposed within the recessed portion of the locking support body before the locking support body is installed on the first fitting (i.e. pre-assembled).

The invention further relates to an annular locking ring element operable to be used in a locking assembly. The locking ring element includes an internal portion including internal threads, a wrench portion including a plurality of sides, a camming portion including a plurality of sides, wherein the average diameter of the camming portion is smaller than the average diameter of the wrench portion, and a flange portion having an average diameter that is larger than the average diameter of the first portion and the average diameter of the second portion.

The wrench and camming portions each preferably have at least three sides, for example, three or six sides, and they may have the same or different numbers of sides. In addition, the sides of the wrench and/or camming portions may be curved. Furthermore, the camming portion preferably has a smaller average diameter than the wrench portion. Moreover, the flange portion preferably has a larger average diameter than the wrench portion and the camming portion, and is preferably circular.

These and other features of the invention will become more apparent from the following detailed description of the invention when viewed in conjunction with the accompanying drawings.

### BRIEF DESCRIPTION OF THE DRAWINGS

FIG. 1 is a side view of a locking device assembly according to one aspect of a preferred embodiment of the invention.

FIG. 2 is a cross-sectional view of a locking ring element and locking support body according to one aspect of a preferred embodiment of the invention.

FIG. 3 is an exploded view of a locking ring element and locking support body according to one aspect of a preferred embodiment of the invention.

FIG. 4 is a transverse view of a locking ring element and locking support body according to one aspect of a preferred embodiment of the invention.

FIG. 5 is a side view of a locking device assembly according to one aspect of a preferred embodiment of the invention.

FIG. 6 is a cross-sectional side view of a locking device assembly according to one aspect of a preferred embodiment of the invention.

FIG. 7 is a side view of a locking ring element according to one aspect of a preferred embodiment of the invention.

FIG. 8 is a transverse view of a locking ring element according to one aspect of a preferred embodiment of the invention.

FIG. 9 illustrates an expansion spring according to one aspect of a preferred embodiment of the invention.

FIG. 10 is a cross-sectional view of a locking ring element and locking support body according to one aspect of a preferred embodiment of the invention.

FIG. 11 is a side view of a locking ring element and locking support body according to one aspect of a preferred embodiment of the invention.

FIG. 12 is a transverse view of a locking ring element and locking support body according to one aspect of a preferred embodiment of the invention.

FIG. 13 is a transverse view of a locking ring element according to one aspect of a preferred embodiment of the invention.

FIG. 14 is a transverse view of a locking ring element and locking support body according to one aspect of a preferred embodiment of the invention.

FIG. 15 is an exploded view of the locking assembly of the invention according to one aspect of a preferred embodiment of the invention.

FIG. 16 is a side view of a locking device according to one aspect of a preferred embodiment of the invention.

### DETAILED DESCRIPTION OF THE INVENTION

As is indicated above, this application is a continuation-in-part of U.S. patent application Ser. No. 10/938,499, filed Sep. 13, 2004, which is hereby incorporated by reference in its entirety. It should be noted that the specific features of the locking devices and assemblies described in U.S. patent application Ser. No. 10/938,499 may be applied to the locking devices and assemblies described herein, as appropriate.

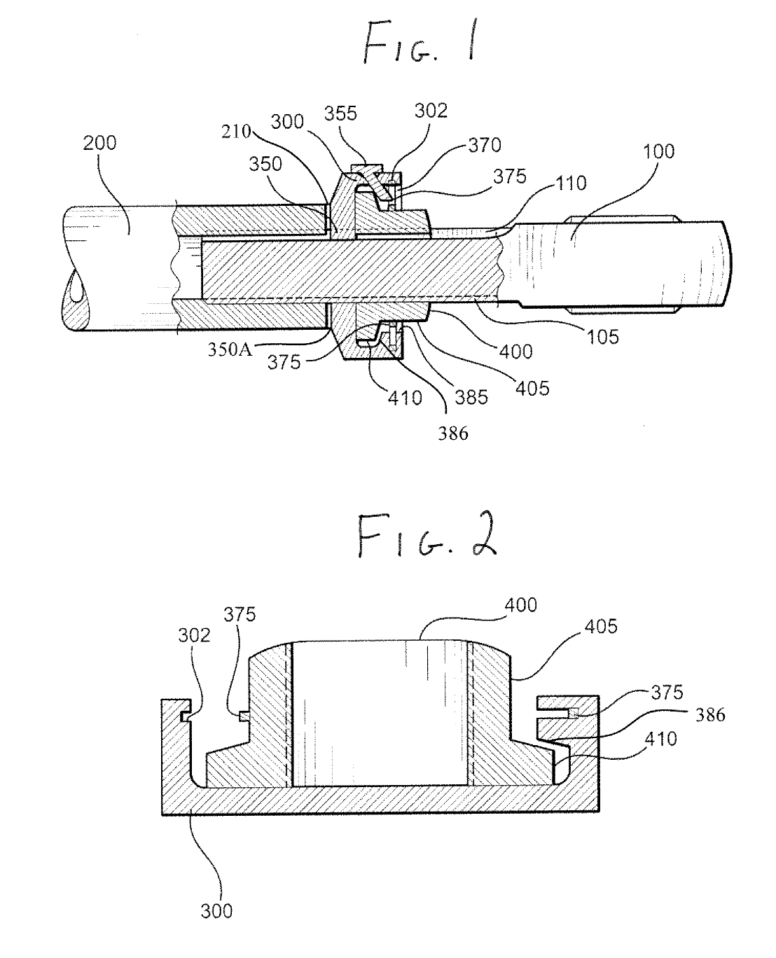

Referring now to the figures, first fitting 100 and second fitting 200 are rod-type fittings, such as actuator pistons and rod-ends. First fitting 100 may be either a rod-end portion or a piston portion, provided it meets the requirements described herein. FIG. 1, for example, illustrates first fitting 100 to be a rod-end portion, while FIG. 16, for example, illustrates first fitting 100 to be a piston portion. First fitting 100 is formed of steel, or any other suitable material, and the portion of first fitting 100 that is relevant to the invention is generally cylindrically shaped, with an external threaded portion 105. Threaded portions, such as external threaded portion 105, are common in the art, and are formed to rotationally engage internally threaded portions of other components, such as nuts or internally threaded female components. Special threading is not required by the invention.

In addition, first fitting 100 preferably includes a longitudinal groove 110. Longitudinal groove 110 is formed in the surface of first fitting 100 by machining, routing, or the like, and extends longitudinally from the end of first fitting 100 that is threaded into second fitting 200 along the threaded portion 105 of first fitting 100 towards the other end of first fitting 100. The sides of longitudinal groove 110 are generally vertical relative to the centerline of first fitting 100.

The purpose of longitudinal groove 110 is to facilitate the rotational engagement of first fitting 100 with one or more additional components, if desired. Accordingly, the depth and width of longitudinal groove 110 may vary. However, longitudinal groove 110 should be sized such that, if another component is positioned within longitudinal groove 110, and does not move in an outward direction, the sides of longitudinal groove 110 will prevent that component from rotating relative to first fitting 100 as a result of the rotational engagement of that component with one or both of the side edges of longitudinal groove 110. For example, and as will become clear in the description that follows, when a locking support body 300 is mounted on first fitting 100, longitudinal groove 110 rotationally engages, for example, a tab portion 350 of locking support body 300, thereby preventing rotation of locking support body 300 relative to first fitting 100.

Second fitting 200 is generally cylindrical in shape and is formed of steel or any other suitable material. Second fitting 200 has an internal threaded portion that is sized appropriately to rotationally engage external threaded portion 105 of first fitting 100, thereby connecting second fitting 200 to first fitting 100. Additionally, a plurality of slots 210 are formed into the end of second fitting 200. Slots 210 are generally rectangular recesses formed in the end of second fitting 200 and extend radially outward from the innermost portion of second fitting 200 to the outer edge of second fitting 210. Slots 210 are sized and spaced to receive the longitudinally extending portions of tab portion 350 and supplemental tab portions 350A when second fitting 200 is positioned adjacent to locking support body 300. There must be at least as many slots 210 as there are tab portions to allow adjacent axial positioning between second fitting 200 and locking support body 300 to occur.

Locking support body 300 is preferably formed of stainless steel or any other suitable material and is generally annularly shaped and sized to fit on first fitting 100. In order to facilitate movement of locking support body 300 relative to first fitting 100, the interior diameter of locking support body 300 is preferably slightly greater than the outer diameter of externally threaded portion 105 on first fitting 100. Furthermore, the inner diameter of locking support body 300 is generally smooth, thus allowing locking support body 300 to slide along first fitting 100 in a longitudinally unobstructed manner when locking support body 300 is mounted on first fitting 100.

As mentioned above, locking support body 300 includes an integral tab portion 350, or some other means of rotationally engaging locking support body 300 to first fitting 100. Tab portion 350 extends both inwardly from the inner diameter of locking support body 300 and longitudinally towards second fitting 200. The longitudinally extending portion of tab portion 350 extends radially from the inner surface towards the outer surface of locking support body 300, and may extend radially to the outermost surface of locking support body 300. Each of the extending portions of tab portion 350 are generally rectangular in shape, with two generally vertical sides extending outwardly from the surface of locking support body 300. Thus, tab portion 350 extends inwardly from locking support body 300 and fits within longitudinal groove 110 when locking support body 300 is mounted or installed on first fitting 100. The sides of the extending portion of tab portion 350 that extends inwardly from the inner surface of locking support body 300 engage with the sides of longitudinal groove 110 upon application of a rotational force, thereby preventing locking support body 300 from rotating relative to first fitting 100. However, the engagement of tab portion 350 and longitudinal groove 110 does not prevent locking support body 300 from sliding longitudinally along first fitting 100. Instead, when locking support body 300 slides along the length of first fitting 100, tab portion 350 slides along first fitting 100 within longitudinal groove 110.

Locking support body 300 also includes one or more supplemental tab portions 350A. Unlike tab portion 350, supplemental tab portions 350A do not extend inwardly from the inner diameter of locking support body 300. Instead, supplemental tab portions 350A only extend longitudinally from locking support body 300 towards second fitting 200. The longitudinally extending portions of tab portions 350A are positioned in a radial manner with the innermost end near the inner surface of locking support body 300. As with tab portion 300, the longitudinally extending portions of supplemental tab portions 350A are generally rectangular in shape, with two generally vertical sides extending outwardly from the surface of locking support body 300. It is preferred that a total of two tabs be used, with one primary tab 350 and one supplemental tab 350A.

The longitudinally extending portions of tab portion 350 and supplemental tab portion 350A are sized, shaped, and positioned appropriately to fit within slots 210 of second fitting 200. As described above, when locking support body 300 is positioned adjacent to second fitting 200, tab portion 350 and supplemental tab portions 350A fit within slots 210. When forces tending to rotate second fitting 200 relative to locking support body 300 are applied, the sides of tab portion 350 and supplemental tab portions 350A abut the sides of slots 210, thereby preventing further rotation. Accordingly, since locking support body 300 cannot rotate relative to first fitting 100 because of the engagement of tab portion 350 and longitudinal groove 110, when slots 210 are engaged with tab portion 350 and supplemental tab portions 350A, second fitting 200 also cannot rotate relative to first fitting 100.

Locking support body 300 also includes a wide recessed portion 370 capable of receiving a locking ring element 400. Recessed portion 370 is generally annular in shape and is sized appropriately to allow locking ring element 400 to fit within recessed portion 370. An outer portion of locking support body 300 surrounds recessed portion 370, longitudinally overlapping a flange portion 410 of locking ring element 400 when locking ring element 400 is positioned within recessed portion 370. Flange portion 410 is a larger diameter portion of locking ring element 400 that is preferably circular in shape. In addition, recessed portion 370 includes one or more longitudinal limit stops 386, which extend radially inward from the inner surface of recessed portion 370.

Locking ring element 400, which is preferably a nut or any other suitable device, is formed of stainless steel or any other suitable material. Accordingly, locking ring element 400 is generally annular in shape and generally includes a wrench portion 405 which includes a plurality of sides, and also include flange portion 410. The sides of wrench portion 405 may be straight or curved, and preferred wrench portions have at least three sides, with either three or six sides being most preferred. Locking ring element 400 may also include a camming portion 420, as is shown in FIGS. 13-15, for example. Camming portion 420 preferably has a smaller average diameter than wrench portion 405, thereby creating an offset between the sides of camming portion 420 and the sides of wrench portion 405.

The sides of wrench portion 405 of locking ring element 400 preferably each include a portion that can be gripped for rotation by any known tool, for example, a wrench. Additionally, locking ring element 400 is also internally threaded and sized to threadably engage first fitting 100. The internal threads of locking ring element 400 are preferably special internal threads that, when a sufficient amount of torque is applied to locking ring element 400, become locked in engagement with external threaded portion 110 of first fitting 100. One example of an acceptable locking ring element is the Spiralock® fastener manufacturer by the Spiralock Corporation.

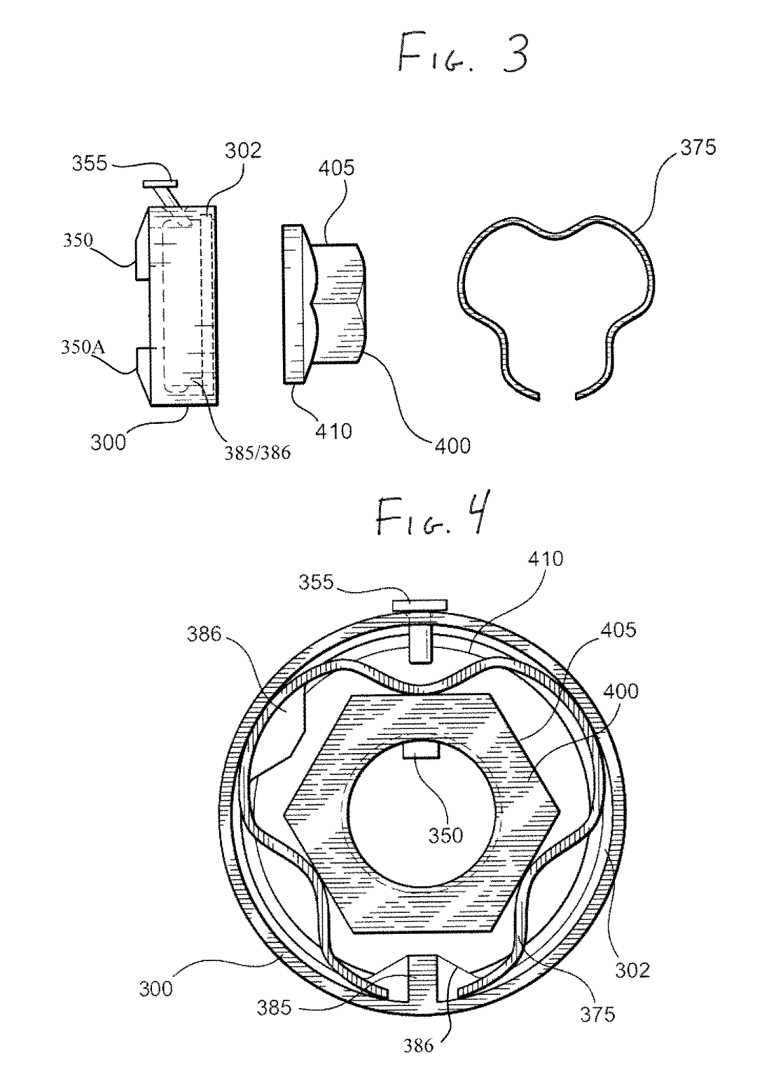

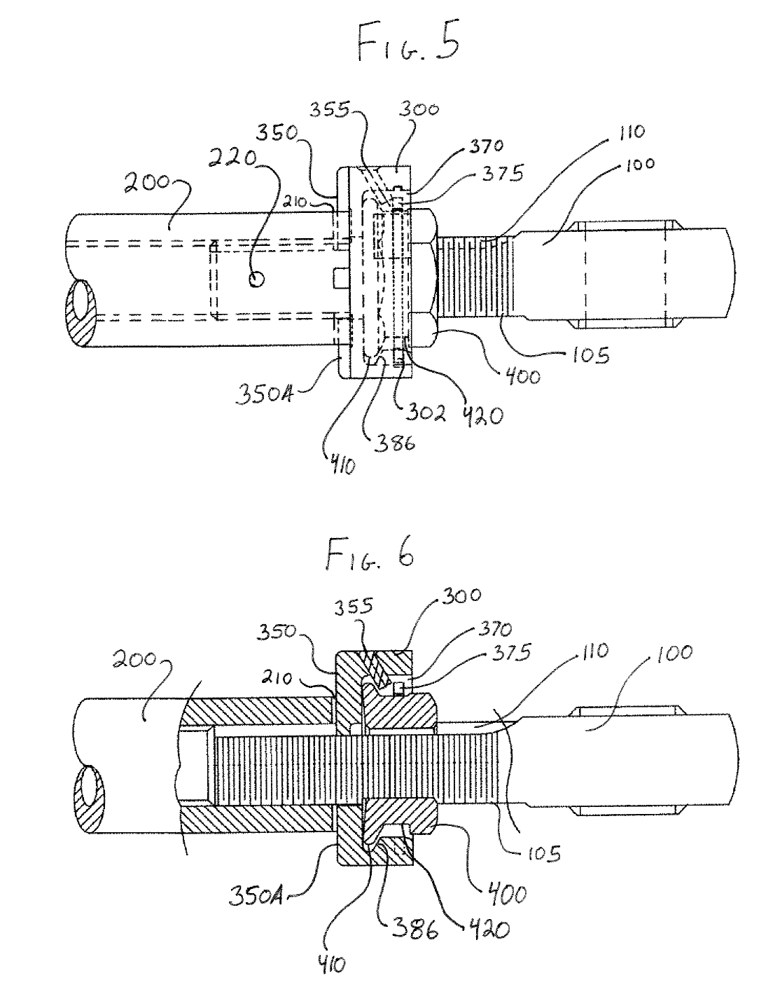

When locking ring element 400 is positioned within recessed portion 370 of locking support body 300, locking ring element is retained within recessed portion 370 by one or more retaining elements. Exemplary retaining elements include, for example, a retaining pin 355 and longitudinal limit stops 386. One or more retaining pins 355 are inserted through appropriately sized bores in the outer portion of locking support body 300 surrounding recessed portion 370. Retaining pin 355 passes through the outer portion of locking support body 300 in a generally transverse manner, and extends into recessed portion 370 sufficiently to radially overlap flange portion 410 of locking ring element 400. Retaining pin 355 may be secured in place relative to locking support body 300 by any means known in the art, for example, press-fitting. In addition, retaining pin 355 may have a traditional head, such as is shown in FIGS. 1, 3, and 4, or may be counter-sunk into locking support body 300, such as is shown in FIGS. 5, 6, 11, 12, 14, and 15. The counter-sunk design in preferred, as it prevents tampering and inadvertent removal of the retaining pin. In addition, as is shown in FIGS. 5, 6, 11, 12, 14, and 15, (as compared to FIGS. 1, 3, and 4), additional material is preferably added to the portion of the locking support body through which the retaining pin is inserted to facilitate the counter-sunk positioning of the retaining pin and to strengthen that portion of the locking support body.

If locking ring element 400 and locking support body 300 begin to axially separate, longitudinal limit stops 386 and retaining pin 355 come into contact with and axially abut flange portion 410 of locking ring element 400, thereby preventing further separation. Thus, longitudinal limit stops 386 and retaining pin 355 prevent locking ring element 400 from exiting recessed portion 370, thereby maintaining the structural integrity of the locking device.

In addition, an expansion spring 375 is preferably positioned around locking ring element 400 within recessed portion 370 and is maintained in its specific longitudinal position by circumferential grooves 302. Expansion spring 375 is used to prevent inadvertent rotation of locking ring element 400 within recessed portion 370, and thus, to prevent separation of locking ring element 400 from locking support body 300, and locking support body 300 from second fitting 200. Spring 375 is preferably an expansion spring, such as a “Marcel Expansion Spring”, as is known in the art, and is formed of stainless steel, spring steel, or the like. Spring 375 is preferably made of a square or circular spring that is shaped into a generally round spring element with a sine wave pattern. The innermost portions of each sine wave of spring 375 may either contact the sides of wrench portion 405 of locking ring element 400, or more preferably, the sides of camming portion 420, when used. The outermost portions of each sine wave of spring 375 contact the inner surface of locking support body 300, and are preferably fitting within circumferential grooves 302 formed in the inner surface of locking support body 300 facing recessed portion 370. Groove 302 preferably extends the entire circumference of the innermost portion of locking support body 300 facing recessed portion 370, but may instead consist of a plurality of smaller, custom fit grooves design specifically to retain portions of the expansion spring.

After locking ring element 400 is positioned within recessed portion 370, spring 375 is inserted into recessed portion 370 such that the innermost portions of spring 375 are in contact with the sides of wrench portion 405, or, preferably, the sides of camming portion 420, of locking ring element 400 and the outermost portions of spring 375 are positioned within grooves 302. Because the outermost portions of the sine waves of spring 375 are positioned within groove 302, longitudinal movement of spring 302 relative to first fitting 100 is prevented. The inclusion of spring 375 as a locking ring element 400 retention device prevents inadvertent rotation of locking ring element 400 relative to locking support body 300. In particular, the inward force of spring 375 against locking ring element 400 is sufficient to prevent rotation due to operational forces, such as vibrations, etc. However, the spring forces of spring 375 may be overcome manually during installation by using a tool, such as a wrench, to rotate locking ring element 400, which allows the locking ring element to be rotated and tightened against locking support body 300 during installation.

Moreover, locking support body 300 preferably includes rotational limit stop 385 within recessed portion 370. Rotational limit stop 385 is formed onto the interior diameter locking support body 300 and extends inwardly into recessed portion 370. Rotational limit stop 385 prevents spring 375 from rotating relative to locking support body 300, and thus, eliminates the possibility of spring 375 rotating with locking ring element 400. Accordingly, if locking ring element 400 begins to rotate relative to locking support body 300 for any reason, spring 375 will rotate with locking ring element 300 until spring 375 comes into contact with rotational limit stop 385, at which point further rotation of spring 375 is prevented.

In addition, longitudinal separation between locking ring element 400 and locking support body 300 is prevented by one or more second limit stops, longitudinal limit stops 386, which may be formed integrally with rotational limit stop 385. Longitudinal limit stops 386 are formed onto the interior diameter locking support body 300 and extend radially inward into recessed portion 370. Each of longitudinal limit stops 386 extend sufficiently inward to longitudinally abut the leading edge of flange portion 410 of locking ring element 400 if forces act to separate locking ring element 400 from locking support body 300. Thus, locking ring element 400 is retained within recessed portion 370 of locking support body 300. In addition, longitudinal limit stop 386 serves to prevent spring 375 from coming into longitudinal contact with locking ring element 400 during operation, thereby protecting the integrity of spring 375 and preventing locking ring element 400 from pushing spring 375 out of grooves 302 and recessed portion 370.

FIGS. 1-4 illustrate an exemplary actuator piston and rod-end locking assembly for locking two fittings together that includes first fitting 100, second fitting 200, locking support body 300, and locking ring element 400, each of which have been described above in great detail. According to this embodiment, locking ring element 400, which is a locking nut with six flat sides, is retained within recessed portion 370 of locking support body 300 by a combination of a pair of longitudinal limit stops 386 and retaining pin 355. In addition, in FIG. 4, expansion spring 375 is positioned within a single groove 302 which extends circumferentially around the inner surface of recessed portion 370 of locking support body 300. As is described above, a plurality of smaller grooves 302 may be used instead of the single circumferential groove.

FIGS. 5-6 illustrate an alternative embodiment in which locking ring element 400 further includes camming portion 420. Camming portion 420 preferably has at least three sides, as is described below with reference to FIG. 13. According to this embodiment, expansion spring 375 is positioned such that it contacts locking ring element 400 on the sides of camming portion 420, thereby adding another layer of security to prevent expansion ring 375 from accidentally coming out of recessed portion 370. In particular, in addition to the outermost portions of expansion spring 375 being contained within grooves, 302, the innermost portions of expansion spring 375 are also retained within the recessed portion by the offset between camming portion 420 of locking ring element 400 and wrench portion 405 of locking ring element 400.

In addition, the embodiment shown in FIGS. 5 and 6 illustrates the use of a viewing hole 220 in second fitting 200, which facilitates visual confirmation that first fitting 100 has been threaded completely into second fitting 200. Furthermore, FIGS. 5 and 6 show an alternative design of tab portion 350 and supplemental tab portion 350A. In particular, the longitudinally extended parts of tab portion 350 and supplemental tab portion 350A extend radially outward beyond the outermost edge of second fitting 200, preferably to the outermost edge of locking support body 300. This design enables easier visual confirmation that tab portion 350 and supplement tab portion 350a are properly positioned in slots 210.

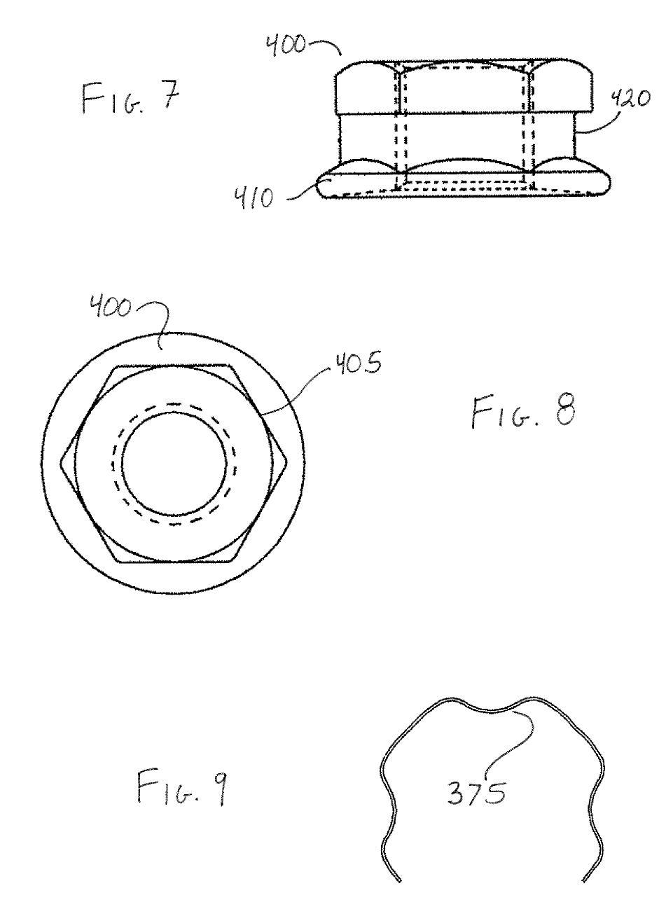

FIGS. 7-8 illustrate expanded views of a six-sided locking ring element. In this case, locking ring element 400 is clearly illustrated to show each of flange portion 410, wrench portion 405, and camming portion 420. FIG. 9 illustrates the shape of an exemplary uncompressed expansion spring 375. It should be noted that any suitably shaped expansion spring may be used.

Because of the above-described features of locking support body 300, locking ring element 400, retaining pin 355, and expansion spring 375, it is possible for the locking assembly consisting of these elements to be pre-assembled without either of first fitting 100 or second fitting 200. Even without either of the fittings, locking ring element 400 will be retained within recessed portion 370 of locking support body 300 by longitudinal limit stops 386 and retaining pins 355, and expansion spring 375 will be retained within grooves 302. In this manner, when the locking assembly is installed onto a first fitting, the entire assembly provides a seamless locking system.

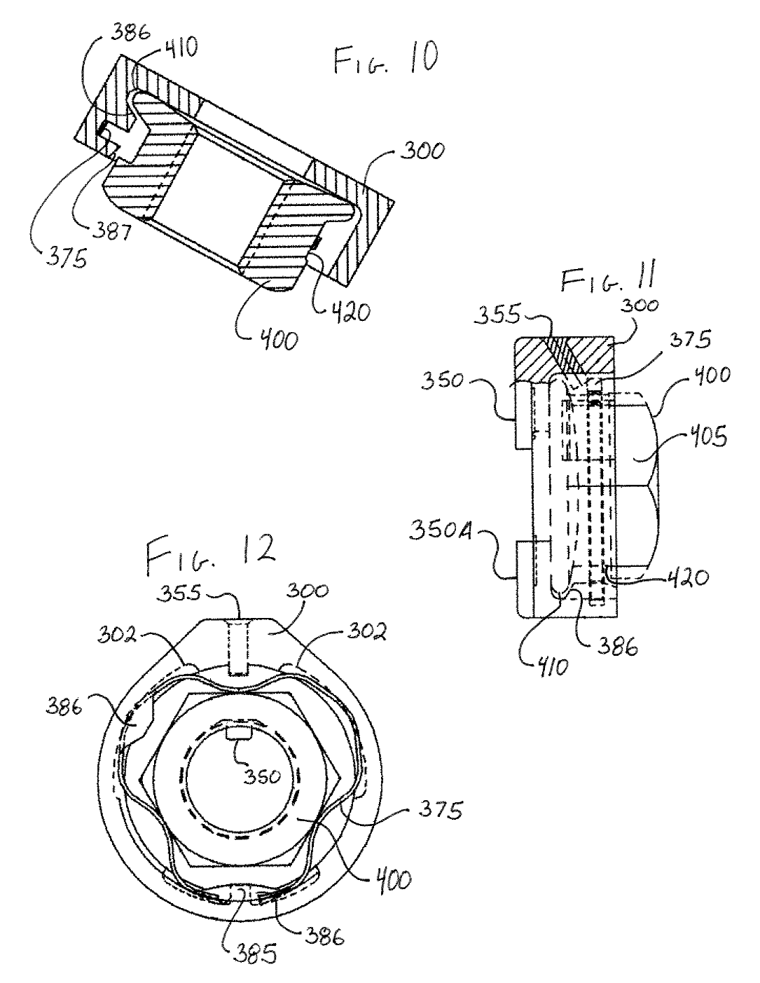

For example, FIGS. 10-12 illustrate views of a six-sided locking ring element that is pre-disposed within a recessed portion of a locking support body of the invention prior to being installed on a first fitting. As can be seen from the figures, locking ring element 400 is retained within recessed portion 370 by three distinct retaining elements: two longitudinal limit stops 386 and a retaining pin 355. In addition, expansion spring 375 is shown to be positioned in contact with the sides of camming portion 420 of locking ring element 400 as is described above. Retaining pin 355 is preferably inserted as the final step of assembly, and prevents the locking ring element 400 from inadvertently backing off or interfering with the spring 375. In addition, retaining pin 355 may be removed, if necessary, to facilitate replacement of expansion spring 375 or locking ring element 400, should the need arise. Removal of the retaining pin can be achieved through any know means in the art, for example, by prying the head of the retaining pin out if the head of the retaining pin is a traditional head, or by pushing the retaining pin out of the locking support body from within the recessed portion of the locking support body if the retaining pin head is counter-sunk into the locking support body. Furthermore, FIG. 12 illustrates a preferred configuration of grooves 302 which are designed to specifically accommodate the outermost portions of expansion spring 375. As is taught above, the use of a single groove extending circumferentially around the innermost surface of recessed portion 370 is also acceptable.

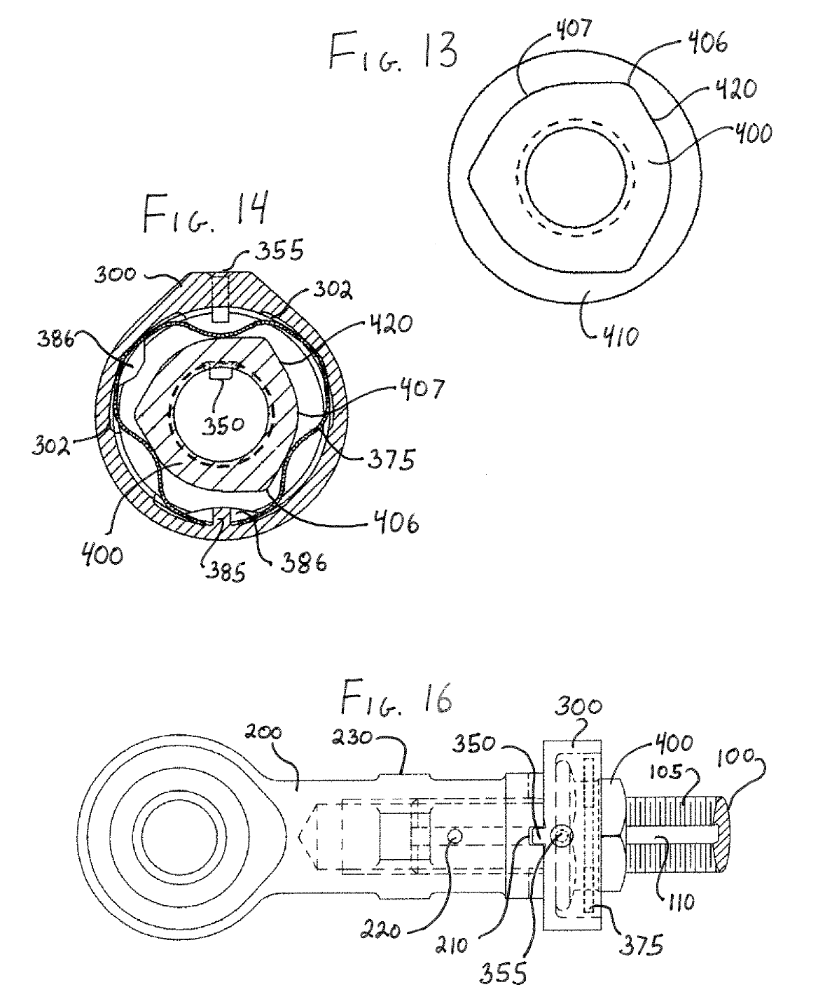

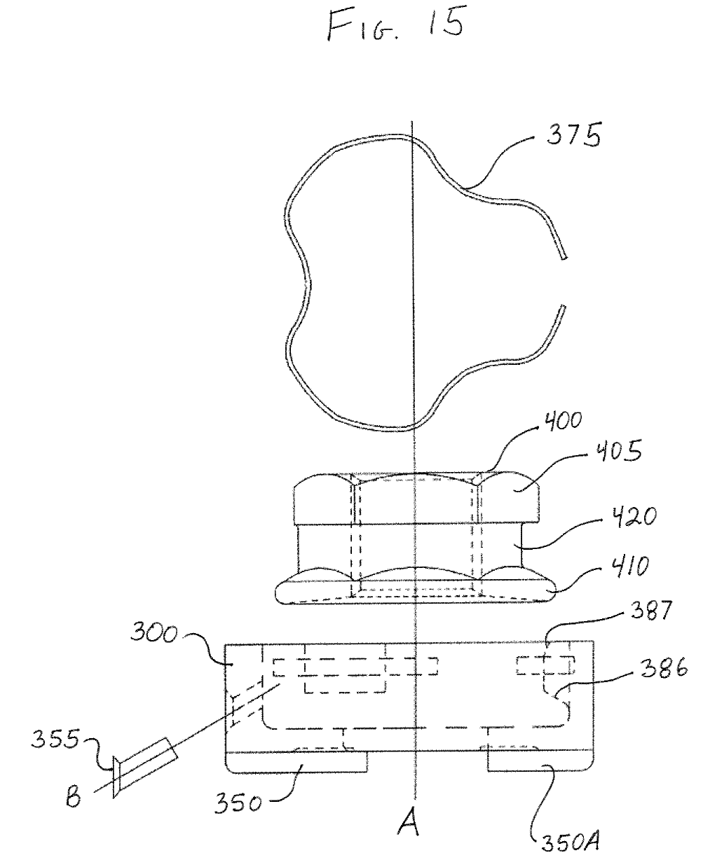

FIGS. 13 illustrates a tranverse view of camming portion 420 of locking ring element 400, and FIG. 14 illustrates a transverse view of the locking ring element of FIG. 13 pre-disposed within recessed portion 370 of locking support body 300 prior to being installed on a first fitting. Camming portion 420 is of a size and shape to be suitable for use as a cam surface for the expansion spring 375. In this regard, it is preferred that camming portion 420 have a different size and shape than wrench portion 405 of locking ring element 400 including wrench portion 405. For example, FIGS. 13 and 14 illustrate a camming portion 420 of locking ring element 400 that has three curved sides. This shape is corresponds to the shape of expansion ring 375 and facilitates contact of the locking ring element with the expansion spring at each of the innermost portions of the expansion spring. In addition, when a three-sided camming portion 420 is used, the differing radii of the sides of camming portion 420 (i.e. maximum radius portions 406 and minimum radius portions 407) optimize the camming effect of camming portion 420 on expansion spring 375 without causing unnecessary compressions of expansion spring 375 during rotation of the locking ring element. Referring to FIG. 14, as locking ring element 400 is rotated, it is clear that the innermost portions of expansion spring 375 will be compressed outwardly as they come into contact with maximum radius portions 406, and will be less compressed as they come into contact with minimum radius portions 407. Thus, inadvertent rotation of locking ring element 400 is prevented. It should be noted that camming portion 420 may be of any size and shape suitable to engage expansion spring 375 as is described herein. Wrench portion 405 (not shown) may also still be included on locking ring element 400 for use by a tool, such as a wrench, to facilitate tightening of the locking ring element.

FIG. 15 is an exploded side view of the embodiment shown in FIGS. 13-14. In particular, FIG. 15 illustrates the four basic components of an exemplary locking assembly: locking support body 300, locking ring element 400, expansion spring 375, and retaining pin 355. As is described in detail above, locking ring element 400 includes wrench portion 405, camming portion 420, and flange portion 410. In addition, locking support body 300 includes tabs 350 and 350A, one or more longitudinal limit stops 386, a chamfer 387, and a bore for receiving retaining pin 355. Chamfer 387 is a relatively small chamfer that is made in locking support body 300 to facilitate insertion of locking ring element 400 into the recessed portion of locking support body 300.

In addition, line A represents the orientation of the components of the locking assembly relative to the axis of the fittings. Line B represents the direction of insertion of retaining pin 355 into locking support body during assembly. FIG. 15 also illustrates the preferred order of assembly for the components of the locking assembly. In particular, according to a preferred embodiment of the invention, the first step of assembly is to insert locking ring element 300 into the recessed portion of locking support body 300. After locking ring element 400 is positioned within locking support body 300, expansion spring 375 is inserted into the recessed portion of locking support body 300 such that the innermost portions of expansion spring 375 are in contact with the sides of camming portion 420 of locking ring element 400. Finally, after expansion spring element 375 is positioned, retaining pin 355 is inserted into locking support body 300. Thus, the completed locking assembly can be assembled prior to be installed on a first fitting.

FIG. 16 illustrates an alternative embodiment in which first fitting 100 is a piston portion, and second fitting 200 is a rod-end portion. As can be seen in the figure, the remaining features of the invention are similar to the embodiment shown in FIGS. 5 and 6. However, in this embodiment, second fitting 200 also includes a plurality of circumferentially arranged gripping surfaces 230, which are preferably flat surfaces that facilitate gripping of the second fitting with a tool, such as a wrench, to secure the second fitting, if needed. Any number of gripping surfaces 230 may be used.

In light of the above disclosure of the invention, it is clear that the invention provides a locking device comprising a plurality of locking features that can be used alone and/or in combination to prevent separation of a first fitting from a second fitting. One locking feature of the invention is comprised of the rotational engagement of tab portion 350 with longitudinal groove 110 to prevent rotation of locking support body 300 relative to first fitting 100. Another locking feature of the invention is comprised of the rotational engagement between slots 210 and either or both of tab portion 350 and supplemental tab portions 350A to prevent rotation of second fitting 200 relative to locking support body 300. An additional locking feature comprises prevention of axial separation between locking ring element 400 and locking support body 300 by using a plurality of retaining elements to retain locking ring element 400 within recessed portion 370 of locking support body 300. Finally, an expansion spring 375 may be used to prevent inadvertent rotation of locking ring element 400 relative to first fitting 100.

In addition, it should be noted that any measurement scale may be used for sizing of the components of the locking device described herein. For example, the threads and/or surfaces of the locking ring element, the first and second fittings, the locking support body, the retaining pin, and the expansion spring may be sized to be compatible with fractional sizes, such as inches, feet, etc. (i.e. ¼″ or ½″), or metric sizes, such as millimeters, centimeters, etc. (i.e. 5 mm or 10 mm). Any suitable sizes or dimensions may be used.

It will thus be seen that the objects set forth above, among those made apparent from the preceding description, are efficiently attained and, since certain changes may be made, in carrying out the above processes, in a described instrument, and in the construction set forth, without departing from the spirit and scope of the invention, it is intended that all matter contained in the above description shown in the accompanying drawings shall be interpreted as illustrative and not in a limiting sense.

It is also to be understood that the following claims are intended to cover all of the generic and specific features of the invention herein described, and all statements of the scope of the invention, which, as a matter of language, might be said to fall there between.

What is claimed is:

1. An actuator piston and rod-end locking assembly for locking two fittings together, the locking assembly comprising:
a first fitting including an exterior threaded portion;
a second fitting including an interior threaded portion, the second fitting being threadably connected to the first fitting via the interior threaded portion;
a locking support body slidably mounted on the first fitting and rotationally engaged to both the second fitting and the first fitting, the locking support body including a recessed portion that extends longitudinally along the first fitting away from the second fitting;
a locking ring element including internal threads, the locking ring element being threadably connected to the first fitting and positioned within the recessed portion of the locking support body such that the locking support body is positioned between the locking ring element and the second fitting; and
an expansion spring element positioned within the recessed portion of the locking support body in substantial rotational engagement with the locking ring element, the expansion spring element being adapted to prevent inadvertent rotation of the locking ring element within the recessed portion relative to the first fitting.

2. The locking assembly of claim 1, wherein the internal threads of the locking ring element are internal locking threads.

3. The locking assembly of claim 2, wherein the internal locking threads of the locking ring element rotationally engage the external threaded portion of the first fitting to form a rotationally locked configuration of the locking ring element and the first fitting, thereby preventing rotation of the locking ring element relative to the first fitting.

4. The locking assembly of claim 1, wherein the locking support body is axially compressed between the locking ring element and the second fitting.

5. The locking assembly of claim 1, wherein the substantial rotational engagement between the locking ring element and the expansion spring can be overcome upon an application of sufficient torque upon the locking ring element.

6. The locking assembly of claim 1, wherein the expansion spring is retained within the recessed portion of the locking support body by one or more retaining elements.

7. The locking assembly of claim 6, wherein the expansion spring is retained within the recessed portion of the locking support body by one or more grooves in the recessed portion.

8. The locking assembly of claim 1, wherein the locking ring element is retained within the recessed portion of the locking support body by one or more retaining elements.

9. The locking assembly of claim 8, wherein at least one of the retaining elements is a retaining pin.

10. The locking assembly of claim 1, wherein the locking ring element and the expansion spring are predisposed within the recessed portion of the locking support body before the locking support body is installed on the first fitting.

11. The locking assembly of claim 1, wherein the locking ring element includes a wrench portion, a camming portion, and a flange portion.

12. The locking assembly of claim 11, wherein the wrench portion has at least three sides.

13. The locking assembly of claim 12, wherein the wrench portion has three sides.

14. The locking assembly of claim 12, wherein the wrench portion has six sides.

15. The locking assembly of claim 12, wherein the sides of the wrench portion are curved.

16. The locking assembly of claim 11, wherein the camming portion has a smaller average diameter than the wrench portion.

17. The locking assembly of claim 11, wherein the camming portion has at least three sides.

18. The locking assembly of claim 17, wherein the camming portion has three sides.

19. The locking assembly of claim 17, wherein the camming portion has six sides.

20. The locking assembly of claim 17, wherein the sides of the camming portion are curved.

21. The locking assembly of claim 17, wherein the expansion spring element is in substantial rotational engagement with the sides of the camming portion.

22. The locking assembly of claim 11, wherein the flange portion has a larger average diameter than the wrench portion and the camming portion.

23. The locking assembly of claim 1, wherein the second fitting includes a plurality of circumferentially arranged gripping surfaces.

24. An annular locking ring element operable to be used in a locking assembly, the locking ring element comprising:
an internal portion including internal threads;
a wrench portion including a plurality of sides;
a camming portion including a plurality of sides, wherein the average diameter of the camming portion is smaller than the average diameter of the wrench portion; and
a flange portion having an average diameter that is larger than the average diameter of the first portion and the average diameter of the second portion.

25. The locking ring element of claim 24, wherein the internal threads of the locking ring element are internal locking threads.

26. The locking ring element of claim 24, wherein the wrench portion has at least three sides.

27. The locking ring element of claim 26, wherein the wrench portion has three sides.

28. The locking ring element of claim 26, wherein the wrench portion has six sides.

29. The locking ring element of claim 24, wherein the sides of the wrench portion are curved.

30. The locking ring element of claim 24, wherein the camming portion has at least three sides.

31. The locking ring element of claim 30, wherein the camming portion has three sides.

32. The locking ring element of claim 30, wherein the camming portion has six sides.

33. The locking ring element of claim 24, wherein the sides of the camming portion are curved.

34. The locking ring element of claim 24, wherein the wrench portion and the camming portion have the same number of sides.

35. The locking ring element of claim 24, wherein the flange portion is circular.
